(19) United States
(12) Patent Application Publication
(10) Pub. No.: US 2009/0050653 A1
(43) Pub. Date: Feb. 26, 2009

(54) Thin-Walled Dosing Device Having An Integrally Moulded Trigger And Spring, And Method For Assembling Same

(75) Inventors: Wilhelmus Johannes Joseph Maas, Someren (NL); Petrus Lambertus Wilhelmus Hurkmans, Someren (NL)

Correspondence Address: BOZICEVIC, FIELD & FRANCIS LLP, 1900 UNIVERSITY AVENUE, SUITE 200, EAST PALO ALTO, CA, 94303, US

(73) Assignee: AFA POLYTEK B.V., Helmond (NL)

(21) Appl. No.: 11/813,024

(22) PCT Filed: Jan. 10, 2006
(86) PCT No.: PCT/NL2006/000012

§ 371 Date: Mar. 21, 2008

(30) Foreign Application Priority Data
Jan. 10, 2005 (NL) 1027982

(51) Int. Cl. B67D 5/40; B23P 11/00

(52) U.S. Cl. 222/383.1; 29/428

(57) ABSTRACT

The invention relates to a device for dosed dispensing of a liquid from a container, comprising a housing (3) manufactured from plastic which can be connected to the container, a pump accommodated therein which can be operated by a trigger (8), and means (14) for resetting the trigger to a starting position. The housing takes a thin-walled form, for instance of polypropylene with a wall thickness of less than 1 mm, and has a number of stiffening ribs (17) extending inward from its side walls, while the pump can have a number of protruding supports engaging on the side walls of the housing. The trigger and the resetting means of the dosing device can be manufactured from a relatively more rigid type of plastic than the housing, for instance from a stiffer variant of the plastic used in the housing and/or the pump, and can be manufactured integrally. The invention also relates to a method for assembling such a dosing device.

The invention relates to a device for dosed dispensing of a liquid from a container, comprising a housing manufactured from plastic which can be connected to the container, a pump accommodated therein which can be operated by a trigger, and means for resetting the trigger to a starting position. Such a dosing device is known as a ‘trigger sprayer’ and is marketed by applicant in many variants.

These dosing devices are usually attached to plastic bottles and used in particular to spray liquid cleaning agents. Because the dosing device in fact forms part of the packaging of the actual product, the cleaning agent, the cost hereof must be as low as possible. The dosing device, which is discarded once the container is emptied, must furthermore be manufactured from readily reusable materials.

The invention thus has for its object to provide a dosing device of the above described type which has a simple construction and can thus be assembled at low cost, and which additionally requires a minimal amount of material, wherein as much of this material as possible is re-usable.

According to a first aspect of the invention, this is achieved in such a dosing device in that the housing takes a thin-walled form and has a number of stiffening ribs extending inward from its side walls. Material usage is minimized by applying a thin-walled housing, while the stiffening ribs ensure that the housing still is and feels sufficiently strong.

A dosing device which can be produced at low cost is obtained when the housing is manufactured from polypropylene and has a wall thickness of less than 1 mm. Compared to for instance PET, polypropylene is a very cheap type of plastic, which can moreover be processed in very small thicknesses.

In order to increase still further the strength of the housing perceived by the user the pump preferably has a number of protruding supports engaging on the side walls of the housing.

According to a second aspect of the invention, there is provided a dosing device of the type described in the preamble, wherein the trigger and the resetting means are manufactured from a relatively more rigid type of plastic than the housing. The parts which are relatively heavily loaded can thus be constructed in sufficiently strong and rigid manner, without the costs for the rest of the dosing device increasing as a result. In order to nevertheless enable processing of the trigger and resetting means together with the other components after use, they are preferably manufactured from a stiffer variant of the plastic used in the housing and/or the pump, such as polypropylene with a high stiffness.

When the trigger and the resetting means are manufactured integrally, assembly of the dosing device is simplified considerably. In order to ensure a reliable operation of the dosing device under all conditions, it is recommended that a transition in the form of at least one connecting part is provided between the trigger and the resetting means, and the trigger and the resetting means are embodied such that, when the at least one connecting part fails, the resetting means still continue to engage on the trigger. This can be achieved in structurally simple manner when the trigger and the resetting means are adapted to form a hook coupling when the at least one connecting part fails.

The resetting means can advantageously comprise at least one flexure spring. An effective resetting movement is thus ensured. When the at least one flexure spring herein extends from the trigger substantially parallel to the direction of movement thereof, and has a free end which engages on a part of the housing or the pump, a compact device is obtained which already generates a considerable resetting force with a relatively small movement.

With a view to simple assembly of the various components the housing preferably consists of at least two parts to be connected to each other.

The invention also relates to a method for assembling a dosing device as described above. According to the invention such a method comprises the steps of:
a) supplying a pump,
b) supplying an assembly of trigger and resetting means,
c) mutually connecting the trigger assembly and the pump,
d) supplying a housing, and
e) placing the housing around and connecting it to the pump, while simultaneously tensioning the resetting means. The method according to the invention makes it possible to form a dosing device in rapid and efficient manner.

When the housing consists of two parts, step e) preferably comprises the sub-steps of:
e1) placing a first part of the housing round and connecting it to the pump,
e2) tensioning the resetting means by placing thereof in engagement with a part of the housing or the pump, and
e3) placing the second part of the housing on the first housing part and connecting it thereto and/or to the pump. The pump can thus be mounted in the housing in simple manner, and tensioning of the resetting means requires only little effort.

A method which can be performed very easily is achieved when a guide is connected to the first housing part for the purpose of tensioning the resetting means, the resetting means are moved along the guide to the tensioned position engaging on a part of the housing or the pump, and the guide is released once again.

In order to limit as much as possible the number of changes and also the number of tools to be used during assembly steps e1) to e3) are preferably carried out in a single mould.

An efficient assembly sequence is achieved when a spray nozzle is further connected to the pump prior to placing of the housing. It is also the case for this process that, with a view to minimizing the operations and tools, it is advantageous that arranging of the spray nozzle takes place in the same mould as the mutual connection of the trigger assembly and the pump.

The invention is now elucidated on the basis of an embodiment, wherein reference is made to the accompanying drawing, in which:

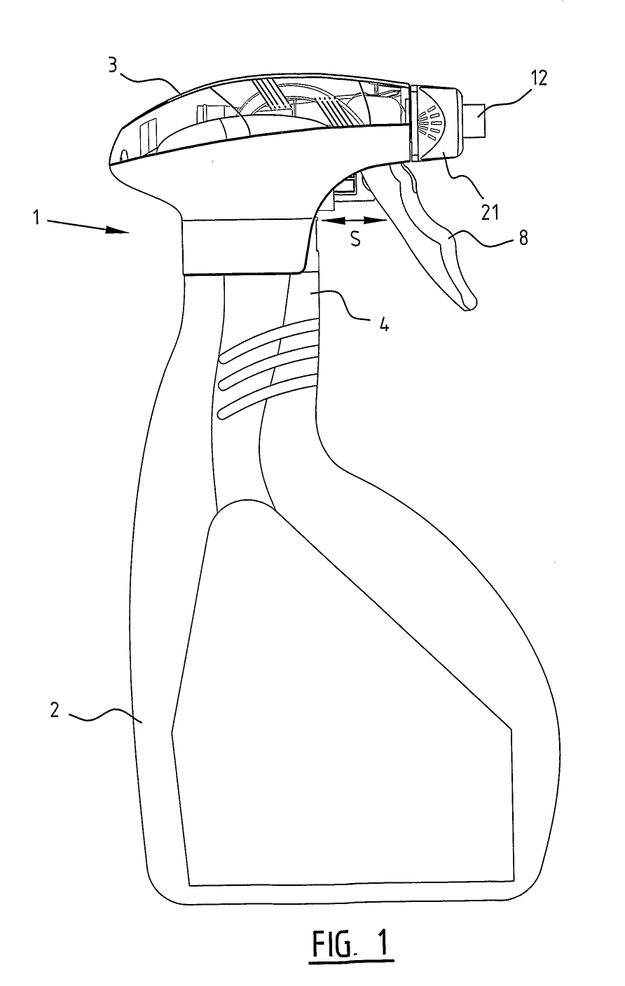

FIG. 1 is a perspective view of a container with a dosing device according to the invention thereon,

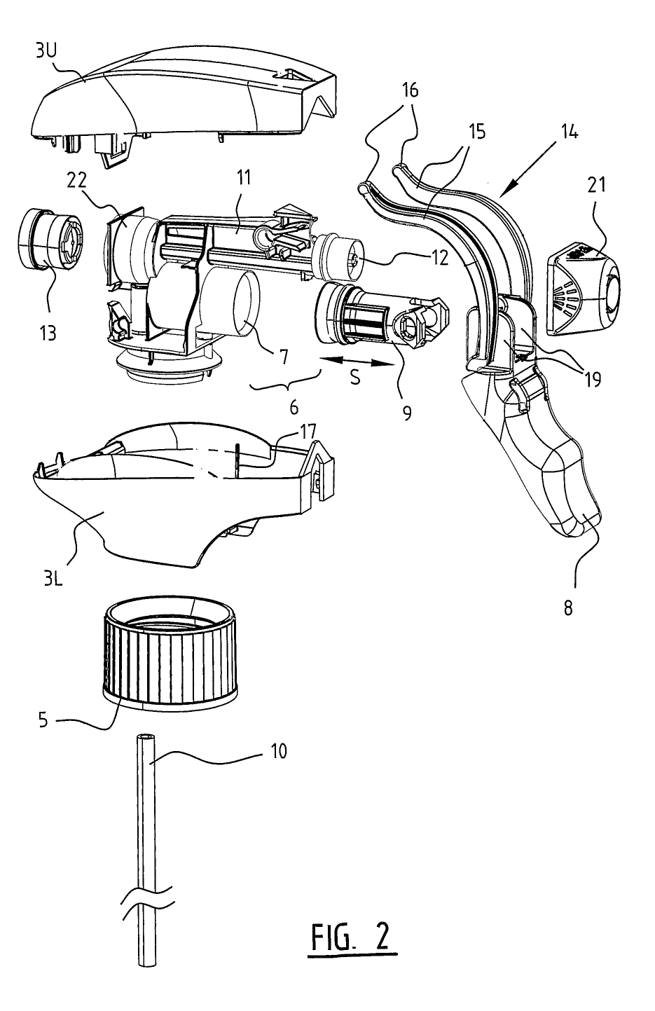

FIG. 2 is a perspective view with exploded parts of the dosing device of FIG. 1,

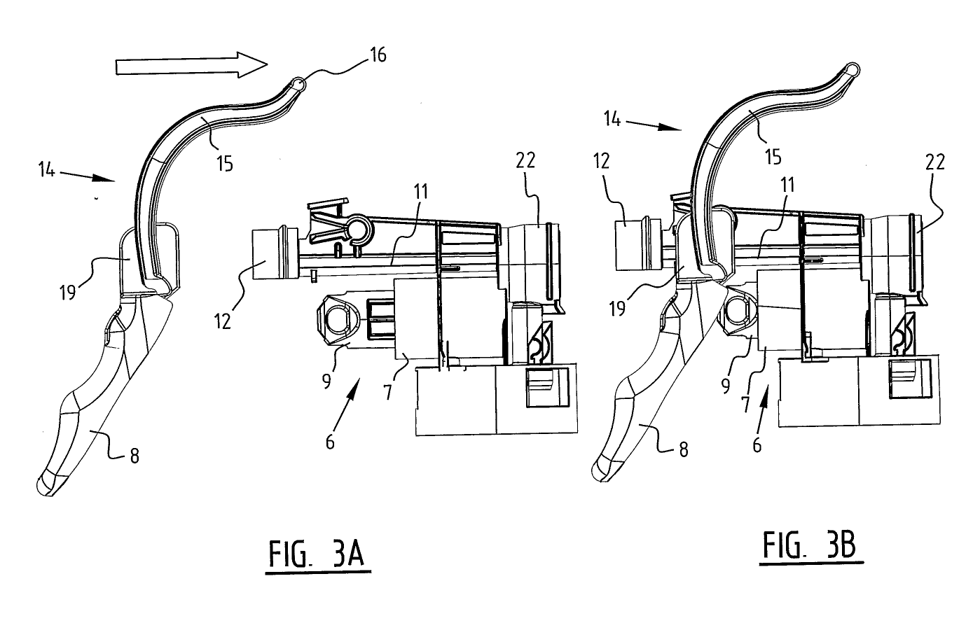

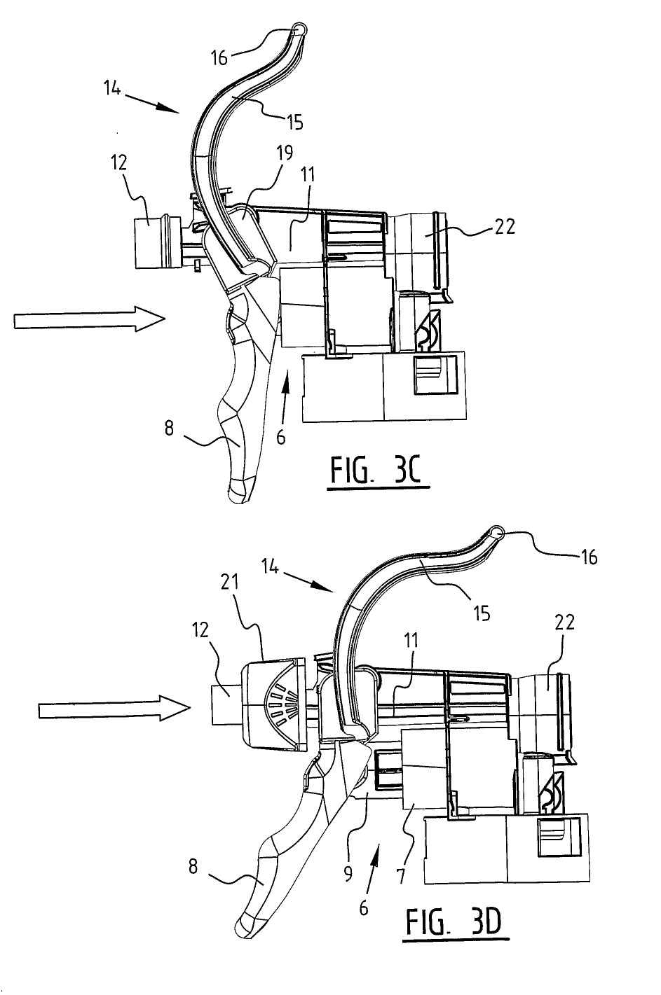

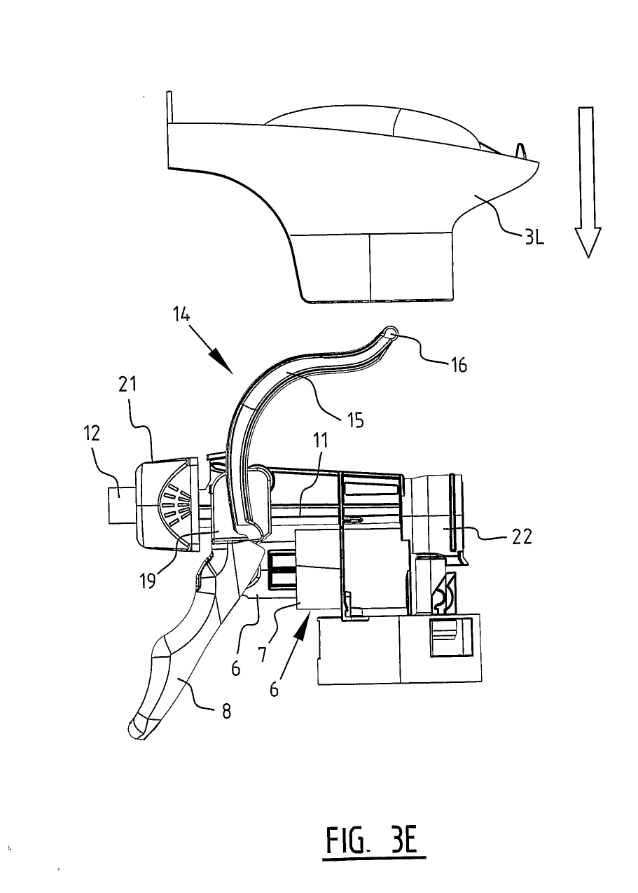

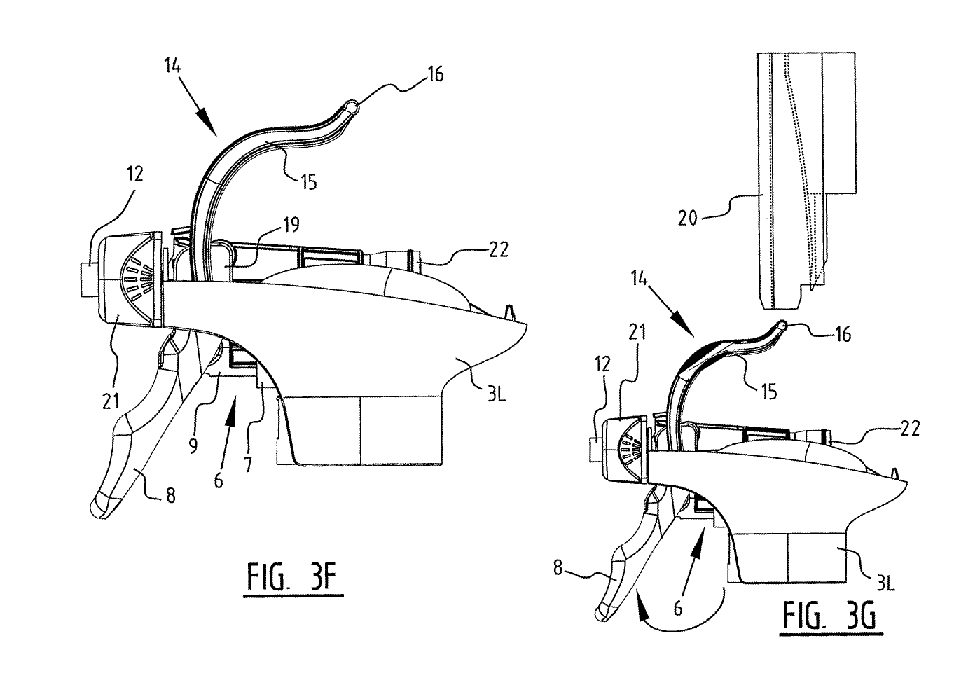

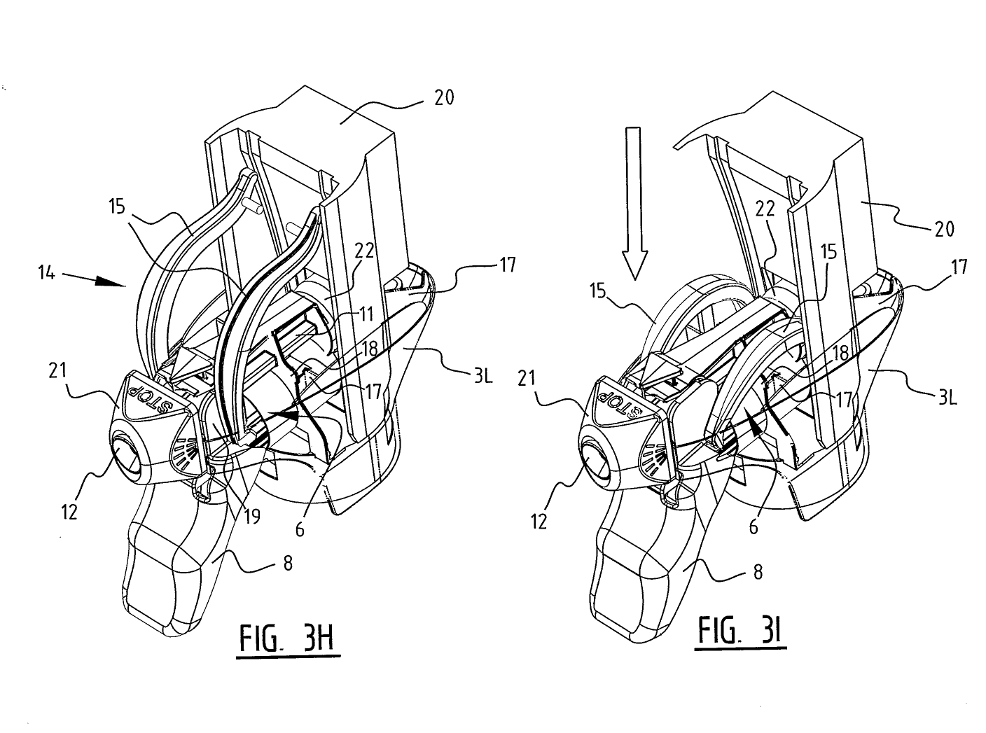

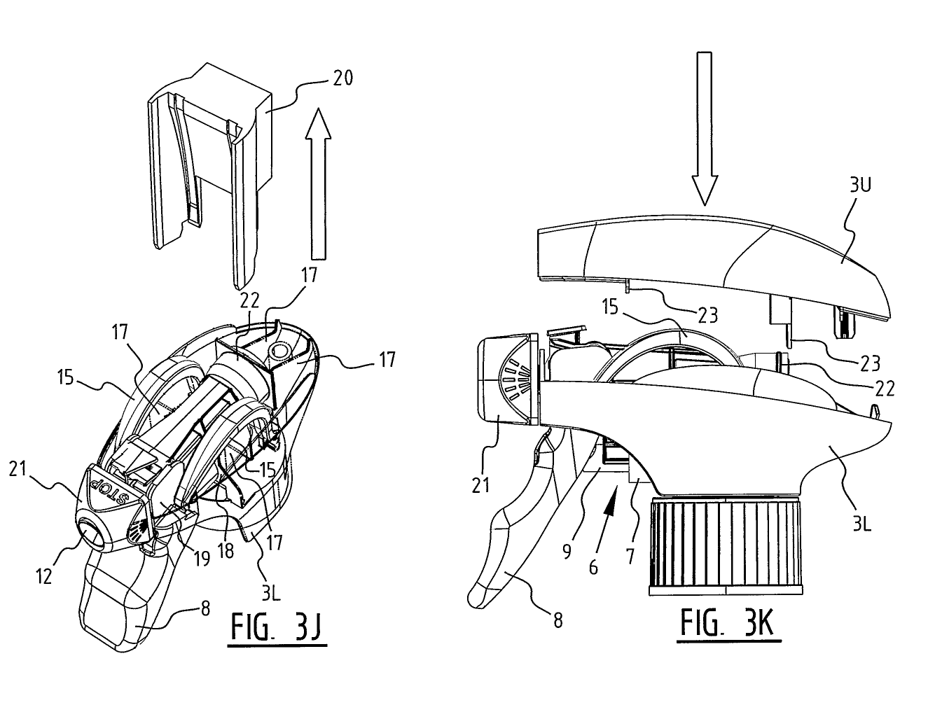

FIG. 3A-3K show the different steps of the method according to the invention partly in side view and partly in perspective view,

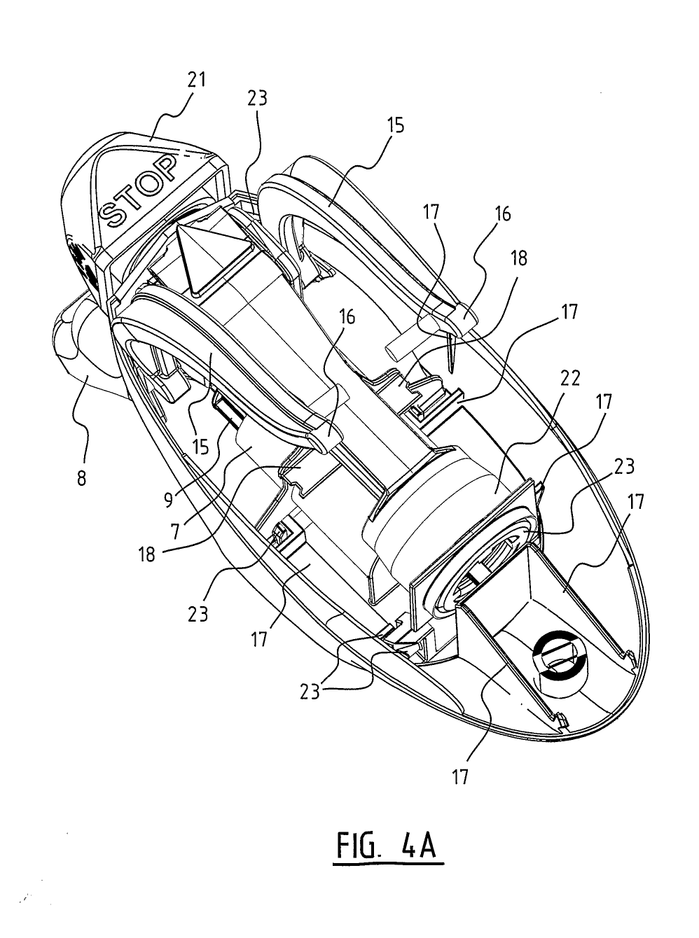

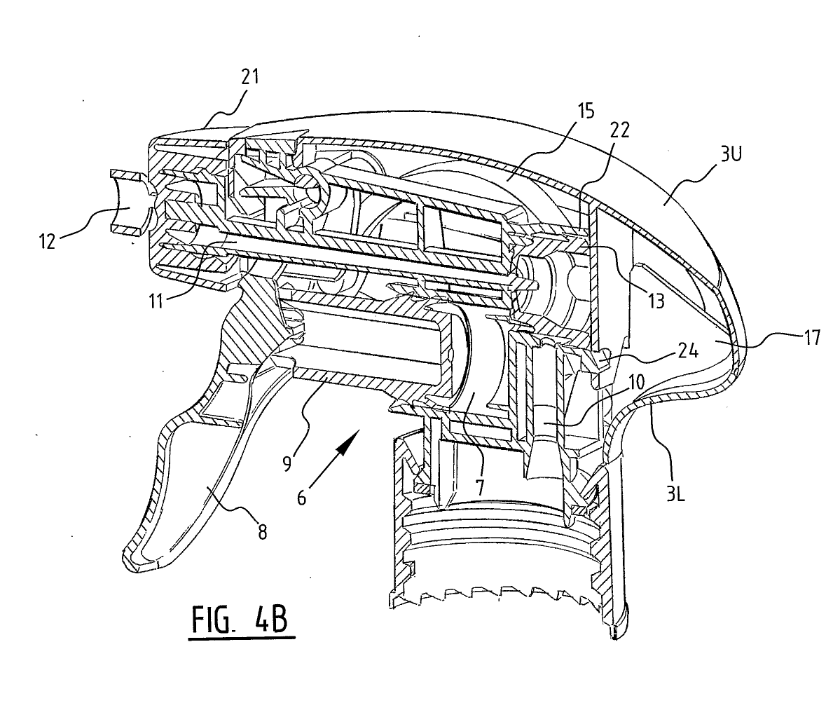

FIGS. 4A and 4B show in perspective view the connection points of the various components,

FIG. 5 is a perspective detail view of the connection between the integrally formed trigger and the resetting means of the dosing device according to the invention,

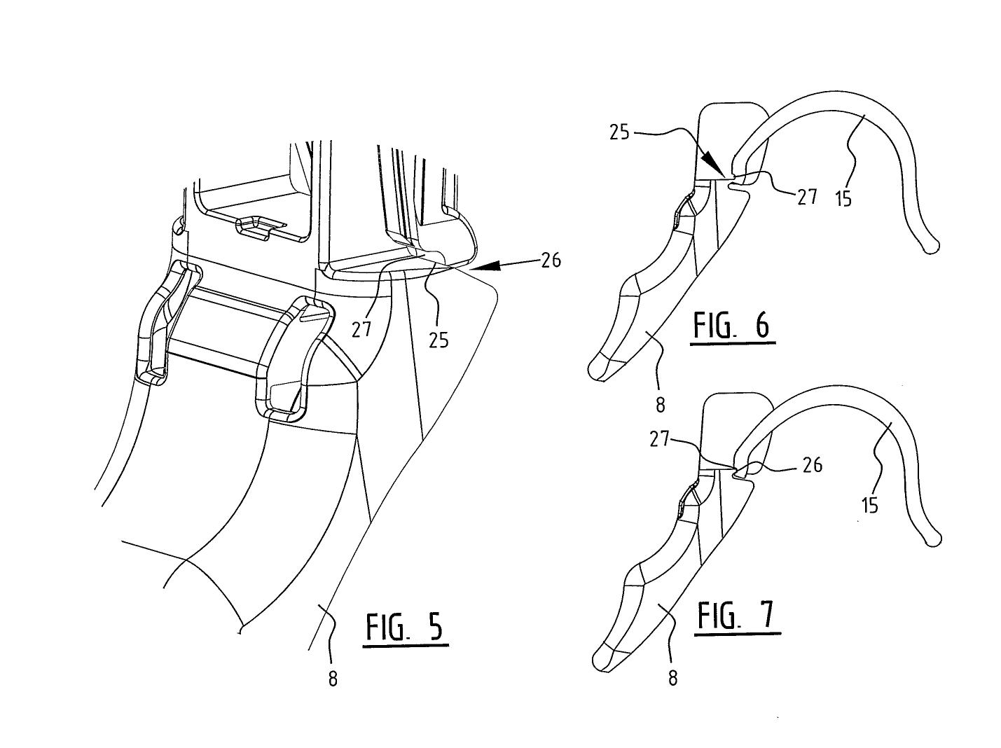

FIG. 6 is a side view of the trigger and the resetting means in tensioned situation, wherein the connection is intact, and

FIG. 7 is a view corresponding with FIG. 6, wherein the connection has failed.

A device 1 for dosed dispensing of a liquid from a container 2 comprises a housing 3 manufactured from plastic, which here consists of a lower half 3L and an upper half 3U (FIG. 2). Housing 3 can be connected to a neck 4 of container 2 by means of a bayonet fitting or, as shown here, a screw connection 5. A pump 6 is accommodated in housing 3. This pump 6 comprises a cylinder 7 and a piston 9 which is reciprocally movable therein and which can be operated by a trigger 8. The suction side of pump 6 is connected to the interior of container 2 via a suction line 10, while the pressure side is connected via a pressure line 11 to an outlet nozzle 12 with control means 21. In the shown embodiment a pre-compression system—already known from applicant—consisting inter alia of a chamber 22 in which is received a sleeve 13 with a dome-shaped valve integrated herein is also arranged between the pressure side of pump 6 and pressure line 11.

Means 14 are further present in housing 3 for resetting trigger 8 to a starting position. In the shown embodiment these resetting means 14 are formed integrally with trigger 8 and take the form of two parallel flexure springs 15 which connect to cheeks 19 on the top side of trigger 8. In the assembled situation these springs 15 extend practically parallel to the stroke direction S of piston 9 and the direction of movement of trigger 8, and support with their outer ends 16 on a part of housing 3 or pump 6.

The transition between trigger 8 and each of flexure springs 15 is formed by a connecting part 25, which is embodied here in flexible manner in the form of a film hinge (FIG. 5). This flexible connecting part 25 enables a pivoting movement of trigger 8 relative to flexure spring 15. Although with a suitable design and choice of material such a film hinge 25 has a long lifespan, there is always the risk of connecting part 25 failing, for instance in the case of very prolonged use or due to an unexpectedly high load. In order to ensure that in this case flexure spring 15 still remains operative for the purpose of resetting trigger 8, trigger 8 and flexure spring 15 are formed and dimensioned such that they then form a hook coupling.

For this purpose the end part 27 of flexure spring 15 adjoining film hinge 25 is given a slightly hollow or hook-like form, while trigger 8 has a straight rear edge 27 at the position of film hinge 25. When film hinge 25 fails the end part 27 of flexure spring 15 will, due to the shape of this end part 27, shoot under rear edge 27 of trigger 8 and be caught therein under the influence of the tension in flexure spring 15 (FIG. 7). Flexure spring 15 thus remains in engagement with trigger 8 and continues to exert a resetting force thereon.

The different components of dosing device 1 are here manufactured from the same material, for instance polypropylene, so that device 1 can be recycled in its entirety. Polypropylene has the advantage that it is relatively inexpensive and is sufficiently strong and stiff to be used in relatively small thicknesses. Polypropylene is moreover very resistant to fatigue, so that it is very suitable for applications where varying loads occur.

Housing 3 and the various components accommodated therein here take a relatively thin-walled form, with a wall thickness in the order of several tenths of a millimetre, for instance 0.8 to 0.9 mm. In order to nevertheless make housing 3 sufficiently strong, or at least make it feel sufficiently strong, the side walls thereof are provided with stiffening ribs 17 (FIG. 4A). Pump 6 can also have a number of protruding supports 18 which engage on the side walls of housing 3. In addition, the snap connection between the two housing halves 3L, 3U also provides some strength.

The more heavily loaded components, in particular trigger 8 and flexure springs 15, are manufactured from a stiffer variant of the plastic used, for instance high stiffness polypropylene, and are also given a thicker form. In addition, trigger 8 also derives extra stiffness from its design, particularly the bent edges thereof.

Assembly of the dosing device proceeds as follows. The assembly of trigger 8 and the flexure springs 15 integrated therewith is first pushed over the pressure line, wherein cheeks 19 enclose pressure line 11 on both sides (FIG. 3A, 3B). Trigger 8 is then snapped onto the already mounted piston 9 (FIG. 3C). Control means 21 for outlet nozzle 12 is then fixed onto the end of the pressure line in the same mould, whereby trigger 8 is confined (FIG. 3D). The lower half 3L of housing 3 is then pushed over the already mounted parts (FIG. 3E) and fixed thereto (FIG. 3F) by means of snap connections 23 (FIG. 4A), whereafter a guide 20 is placed in the lower housing half 3L (FIG. 3G, 3H). Flexure springs 15 are bent downward along this guide 20 until their ends 16 snap fixedly behind protrusions in the lower housing half 3L (FIG. 3I). Guide 20 is then removed (FIG. 3J) and the upper housing half 3U is placed on the lower housing half 3L and fixed thereto (FIG. 3K) by means of snap connections 24 (FIG. 4B).

The invention is not limited to the above given embodiment but can be varied in many ways within the scope of the following claims. In particular, all new aspects can be applied in different combinations, optionally also in combination with conventional dosing devices of this type, while retaining the associated advantages.

1. A device for dosed dispensing of a liquid from a container, said device comprising:
a housing manufactured from plastic which can be connected to the container, wherein said housing has a thin-walled form and a number of stiffening ribs extending inward from its side walls,
a pump accommodated therein which can be operated by a trigger, and
means for resetting the trigger to a starting position.

2. A device according to claim 1, wherein the housing is manufactured from polypropylene and has a wall thickness of less than 1 mm.

3. A device according to claim 1, wherein the pump has a number of protruding supports engaging on the side walls of the housing.

4. A device according to claim 1, wherein the trigger and the resetting means are manufactured from a relatively more rigid type of plastic than the housing.

5. A device according to claim 4, wherein the trigger and resetting means are manufactured from a stiffer variant of the plastic used in the housing and/or the pump.

6. A device according to claim 4, wherein the trigger and the resetting means are manufactured integrally.

7. A device according to claim 6, wherein a transition in the form of at least one connecting part is provided between the trigger and the resetting means, and the trigger and the resetting means are embodied such that, when the at least one connecting part fails, the resetting means still continue to engage on the trigger.

8. A device according to claim 7, wherein the trigger and the resetting means are adapted to form a hook coupling when the at least one connecting part fails.

9. A device according to claim 4, wherein the resetting means comprise at least one flexure spring.

10. A device according to claim 9, wherein the at least one flexure spring extends from the trigger substantially parallel to the direction of movement thereof, and has a free end which engages on a part of the housing or the pump.

11. A device according to claim 1, wherein the housing consists of at least two parts to be connected to each other.

12. A method for assembling a dosing device, said method comprising:
a) supplying a pump which can be operated by a tripper,
b) supplying an assembly of trigger and means for resetting the tripper to a starting position,
c) mutually connecting the trigger assembly and the pump,
d) supplying a housing manufactured from plastic which can be connected to a container, and
e) placing the housing around and connecting it to the pump, while simultaneously tensioning the resetting means,
wherein the housing takes a thin-walled form and has a number of stiffening ribs extending inward from its side walls.

13. The method according to claim 12, wherein the housing consists of two parts, and step e) comprises the sub-steps of:
e1) placing a first part of the housing round and connecting it to the pump,
e2) tensioning the resetting means by placing thereof in engagement with a part of the housing or the pump, and
e3) placing the second part of the housing on the first housing part and connecting it thereto and/or to the pump.

14. The method according to claim 13, wherein a guide is connected to the first housing part for the purpose of tensioning the resetting means, the resetting means are moved along the guide to the tensioned position engaging on a part of the housing or the pump, and the guide is released once again.

15. The method according to claim 13, wherein steps e1) to e3) are carried out in a single mould.

16. The method according to claim 12, wherein a spray nozzle is further connected to the pump prior to placing of the housing.

17. The method according to claim 16, wherein arranging of the spray nozzle takes place in the same mould as the mutual connection of the trigger assembly and the pump.
